(19) United States
(12) Patent Application Publication
(10) Pub. No.: US 2008/0166104 A1
(43) Pub. Date: Jul. 10, 2008

(54) Information recording and reproducing apparatus

(75) Inventor: Shimpei Usui, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/907,014

(22) Filed: Oct. 9, 2007

(30) Foreign Application Priority Data
Jan. 10, 2007 (JP) 2007-001918

(51) Int. Cl. H04N 5/91

(52) U.S. Cl. 386/95; 386/E05.001

(57) ABSTRACT

An information recording and reproducing apparatus in which when dubbing of audio/video information has been executed, by storing information showing that the audio/video information has been dubbed into a memory, a hard disk apparatus, or the like in a video camera, when the user intends to erroneously delete the audio/video information which is not dubbed yet, the user is notified that the audio/video information is not dubbed yet. According to such an apparatus, since such a situation that the user erroneously deletes the non-dubbed audio/video information by misunderstanding that the audio/video information has already been dubbed can be avoided, use efficiency can be improved for the user.

### INCORPORATION BY REFERENCE

The present application claims priority from Japanese application JP 2007-001918 filed on Jan. 10, 2007, the content of which is hereby incorporated by reference into this application.

### BACKGROUND OF THE INVENTION

The invention relates to an information recording and reproducing apparatus and, more particularly, to an information recording and reproducing apparatus for recording information onto a plurality of recording media.

As a background of the present technical field, for example, there are JP-A-2002-50155 and JP-A-2005-182864.

In JP-A-2002-50155, in the column of “Problem”, there is a disclosure of “There is provided a recording and reproducing apparatus in which not only recording and reproduction to/from a cassette type magnetic tape recording medium but also recording and reproduction to/from a hard disk can be executed by using a same loading unit for recording and reproducing as that of a cassette type magnetic tape.” and in the column of “Solving means”, there is a disclosure of “comprising: a loading unit 4 of a cassette type magnetic tape recording medium 5; and recording and reproducing means J for a magnetic tape for executing the recording and reproduction to a magnetic tape 8 of the cassette type magnetic tape recording medium 5 loaded in the loading unit 4, wherein a cassette type hard disk recording medium 6 constructed by assembling a hard disk 12 into a casing 7 is constructed so that it can be freely inserted and removed into/from the loading unit 4, and the apparatus has recording means HK and/or reproducing means HS for the cassette type hard disk recording medium 6 loaded in the loading unit 4.” (refer to Abstract).

In JP-A-2005-182864, in the column of “Problem”, there is a disclosure of “When video data of a large size in a storing apparatus is read out and written onto a recording medium having a small residual capacity, if the size of original data is larger than the residual capacity of the recording medium of a writing destination side, the size of video data is automatically divided so that the video data can be stored in the residual capacity of the recording medium, thereby enabling the video data to be written.” and in the column of “Solving means”, there is a disclosure of “When the original data of a large size of a copying source side of an HDD 16 which is larger than a residual capacity of a DVD 18 is copied to the DVD 18, the residual capacity is detected from the DVD 18 in which the value of the residual capacity has been recorded and the copying source data is divided into a size adapted to be stored into the residual capacity of the DVD 18 and copied onto the DVD 18. At this time, each time the copying source data in the HDD 16 is divided and copied, division information showing that the data has already been copied is formed as a correspondence relation table in correspondence to the copying source data. At the next copying time, when a data portion subsequent to the previous division copy is copied to another recording medium, the copying source data is divided and copied from a position of the previous division information.” (refer to Abstract).

### SUMMARY OF THE INVENTION

In recording media of household video cameras, the media is being changed from a miniDV to a DVD under a background of the rapid spread of hard disk apparatuses and recorders with DVD drives. In association with the spread of DVD video cameras, a recording capacity of the hard disk apparatus is increasing every year and a video camera using the hard disk apparatus as a recording medium of audio/video (A/V) information has also been put on the market. The video camera with the hard disk apparatus has been disclosed in JP-A-2002-50155. The hard disk apparatus has such an advantage that the camera recording can be performed for a long time because its recording capacity is larger than that of the DVD. The hard disk apparatus is generally built in a camera main body. Therefore, unlike the DVD camera, recorded data cannot be easily carried. Although the hard disk apparatus has the large capacity, since its capacity is limited, if data has been recorded into the whole capacity, new A/V information cannot be recorded unless otherwise the unnecessary A/V information is deleted. Under such a background, a video camera having therein two kinds of recording media such as hard disk apparatus and DVD drive has been put on the market. According to such a video camera, it is possible to make the most of such advantages of both of the hard disk apparatus and the DVD drive that the recording capacity of the hard disk apparatus is large and the DVD can be easily carried and stored. In this instance, if a function for dubbing the A/V information recorded in the hard disk apparatus onto the DVD is provided for the camera, for example, the A/V information can be easily dubbed from the hard disk apparatus onto the DVD only in the video camera main body. Therefore, high use efficiency for the user is obtained. As an information recording and reproducing apparatus for recording information onto a plurality of recording media, for example, there is JP-A-2005-182864. The information recording and reproducing apparatus having a function of copying data from a first recording medium to a second recording medium has been disclosed in JP-A-2005-182864.

In the case of the video camera in which the hard disk apparatus of the large capacity has been built in, since a large number of A/V information is recorded into the hard disk apparatus, it is troublesome for the user to manage all of the A/V information. According to the video camera having the two apparatuses such as hard disk apparatus and DVD drive mentioned above, in this instance, generally, the user dubs the A/V information recorded in the hard disk apparatus in order to store it onto the DVD. However, even if the DVD drive has been built in and the dubbing can be easily performed, the user has to memorize which ones of the A/V information in the hard disk apparatus have already been dubbed. There is a possibility that when the user intends to arrange the A/V information in the hard disk apparatus, he misunderstands that the A/V information which is not yet dubbed has already been dubbed, so that he deletes such A/V information from the hard disk apparatus. Since the recorded A/V information is the A/V information which cannot be reconstructed forever and is important to the user, a fact that there is a possibility that the recorded A/V information is erroneously deleted is a serious problem.

To solve the above problem, for example, there is a method whereby when the dubbing of the A/V information is executed, by storing information showing that the A/V information has already been dubbed into a memory, the hard disk apparatus, or the like in the video camera, so that when the user intends to erroneously delete the non-dubbed A/V information, the user is notified of such a fact.

According to the above method, for example, since such a situation that the user misunderstands that the A/V information has already been dubbed, and deletes the A/V information from the hard disk apparatus can be avoided, the information recording and reproducing apparatus whose use efficiency for the user has been improved can be provided. Other problems, means, and effects will be clarified by an embodiment, which will be described hereinafter.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of an information recording and reproducing apparatus;

FIG. 2 is a table showing an example of items of management information of audio/video (A/V) information and information;

FIG. 3 shows a processing flow which is executed upon dubbing;

FIG. 4 is a display screen of a thumbnail display for distinguishing the dubbed A/V information;

FIG. 5 shows a processing flow for the thumbnail display;

FIG. 6 shows a processing flow which is executed when the dubbed A/V information is not dubbed;

FIG. 7 shows a processing flow which is executed when the dubbed A/V information is deleted;

FIG. 8 is a display screen for displaying a warning when the dubbed A/V information is deleted;

FIG. 9 shows a processing flow which is executed when the dubbed A/V information is automatically deleted; and

FIGS. 10A and 10B are display screens which are displayed when the dubbed A/V information is automatically deleted.

### DETAILED DESCRIPTION OF THE INVENTION

An embodiment will be described hereinbelow with reference to the drawings.

An information recording and reproducing apparatus in which an optical disk drive of a DVD or the like and a hard disk apparatus have simultaneously been built will now be described as an embodiment.

The invention will be described with respect to an example on the assumption that dubbing is performed by copying audio/video (A/V) information from the hard disk apparatus to an optical disk recording medium. However, the scope of the invention is not limited to the case where a dubbing source side is the hard disk apparatus and a dubbing destination side is an optical disk recording medium. As recording media of the dubbing source side and the dubbing destination side, the invention can be also applied to other memories, storages, or the like in which information can be recorded.

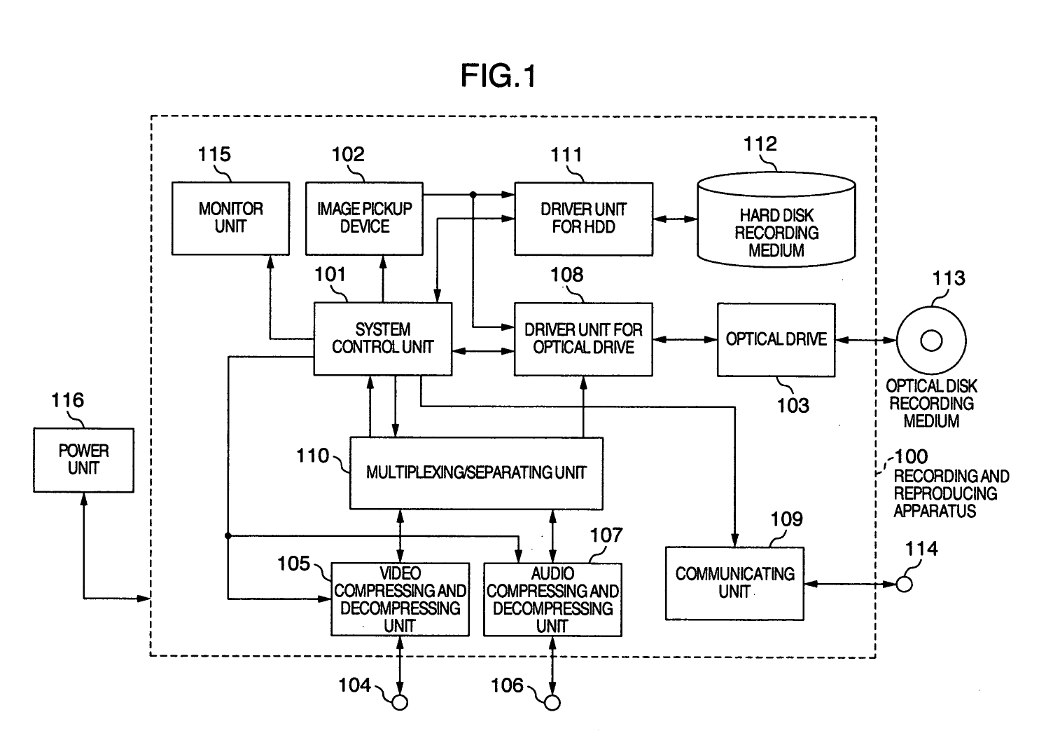

FIG. 1 is a block diagram of the information recording and reproducing apparatus. The information recording and reproducing apparatus can record inputted video information and audio information onto the optical disk recording medium or the hard disk apparatus and can reproduce the recorded information. When the video information and audio information are recorded, they can be recorded and reproduced according to the standard which has been predetermined for each recording medium. The hard disk apparatus can be built in the information recording and reproducing apparatus or may be detachable. If the hard disk apparatus is detachably constructed, since data recorded in the hard disk apparatus can be carried, the data can be easily transferred to another apparatus. A similar effect is also obtained in the case of using a semiconductor memory or the like in place of the hard disk apparatus. The embodiment will be described with respect to the case of using the built-in hard disk apparatus. A kind of DVD is not particularly limited. The invention can be applied to all disks which confirm with the standard of each of a DVD-RAM, a DVD-R, a DVD-RW, a DVD+R, a DVD+RW, and the like. The invention is not limited to the DVD but can be also applied to, for example, a BD (Blu-ray Disc) or HD-DVD as an optical disk recording medium of a large capacity. The embodiment will be described with respect to an example in which an information recording and reproducing apparatus having an image pickup device is used as an example of the information recording and reproducing apparatus. However, the scope of the invention is not limited to the information recording and reproducing apparatus having the image pickup device but can be also applied to a desk-top type recorder, a portable music terminal, or the like which does not have the image pickup device.

In FIG. 1, reference numeral 100 denotes an information recording and reproducing apparatus; 101 a system control unit for controlling a whole system; 102 an image pickup device for photographing an object and photoelectrically converting image pickup information; 103 an optical drive into/from which an optical disk recording medium 113 can be freely inserted and removed; 104 a video input/output (I/O) terminal for inputting and outputting a digital video signal which has been compressed and decompressed in a video compressing and decompressing unit 105; and 106 an audio input/output (I/O) terminal for inputting and outputting a digital audio signal which has been compressed and decompressed in an audio compressing and decompressing unit 107. A multiplexing/separating unit 110 multiplexes video compression data outputted from the video compressing and decompressing unit 105 and audio compression data outputted from the audio compressing and decompressing unit 107, thereby forming stream data, or the multiplexing/separating unit 110 separates the stream data into the video compression data and the audio compression data and inputs those data to the video compressing and decompressing unit 105 and the audio compressing and decompressing unit 107, respectively. Through the system control unit 101, a driver unit 108 for the optical disk recording medium writes the stream data formed by the multiplexing/separating unit 110 and various information files into the optical disk recording medium 113 in a predetermined format or reads out the stream data and the various information files recorded on the optical disk recording medium 113.

Through the system control unit 101, a driver unit 111 for a hard disk apparatus writes the stream data formed by the multiplexing/separating unit 110 and the various information files into a hard disk apparatus 112 in a predetermined format or reads out the stream data and the various information files recorded on the hard disk apparatus 112. A power unit 116 supplies a power source for driving the information recording and reproducing apparatus from a battery or an AC power source for driving the apparatus. The video compressing and decompressing unit 105, the audio compressing and decompressing unit 107, the multiplexing/separating unit 110, the driver unit 108 for the optical disk recording medium, and the driver unit 111 for the hard disk apparatus can be constructed so as to execute the operation as a circuit in a hardware manner or may be constructed in such a manner that they are stored as a program into the system control unit 101 and processes are executed in a software manner. The files in which an information amount of AV data such as video information and audio information has digitally been compressed, the management information of the AV data, and the like have mainly been recorded in the optical disk recording medium 113 and the hard disk apparatus 112. Reference numeral 109 denotes a communicating unit for executing a communicating process with another apparatus such as an information processing apparatus or the like; 114 a communication input/output (I/O) terminal; and 115 a monitor unit for displaying an operation menu of the information recording and reproducing apparatus 100, the video information which is inputted from the image pickup device 102, the video information recorded in the optical disk recording medium and the hard disk apparatus, or the like.

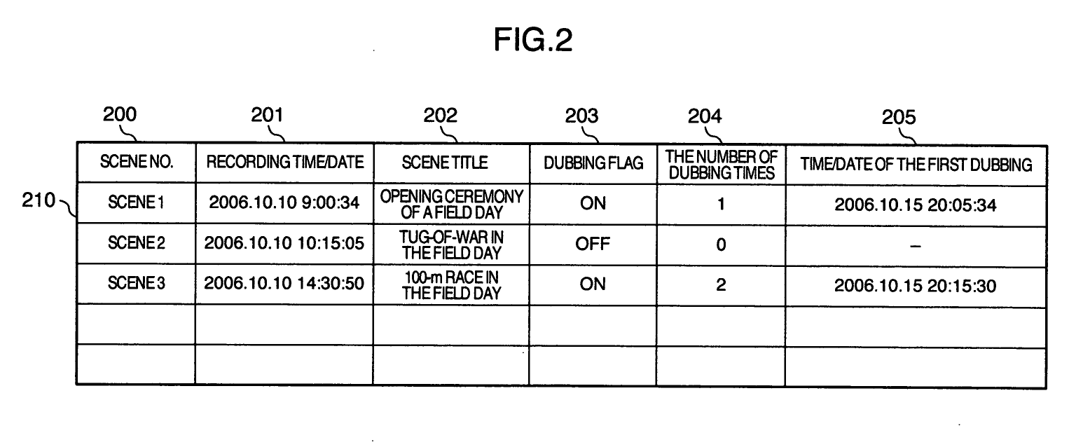

FIG. 2 is a table showing an example of items of the management information of the audio/video (A/V) information and information.

Management information 210 is audio/video (A/V) information recorded by the information recording and reproducing apparatus, that is, what is called information of every scene. Time/date information showing the time/date when the A/V information has been recorded, programs, and title information of the A/V information are included in the management information. As information regarding the dubbing, a dubbing flag, dubbing time/date information, and dubbing number information showing the number of dubbing times are included.

A scene number 200 is a serial number of the recorded A/V information. Each time A/V information is recorded, the number is newly allocated. A recording time/date 201 is information which is stored when the A/V information is recorded. A scene title 202 is title information which is stored by a method whereby after the A/V information was recorded, the user edits the management information. A dubbing flag 203 is information which is stored in order to show that the dubbing has been executed from the hard disk apparatus to the optical disk recording medium. The number of dubbing times 204 is information which is stored in order to show the number of dubbing times. Time/date 205 of the first dubbing is information which is stored in order to show the time/date information at the time when the A/V information has been dubbed for the first time.

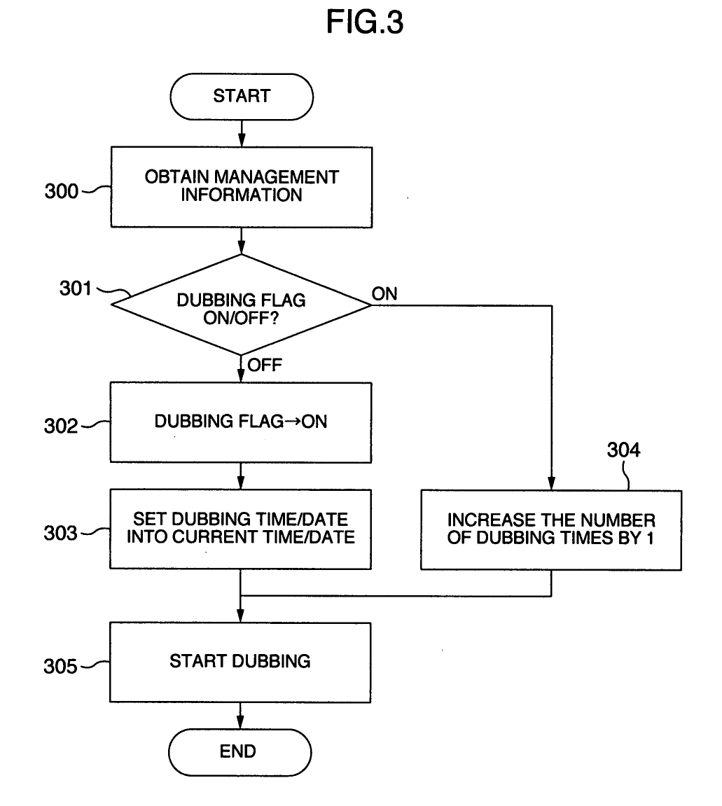

FIG. 3 is a processing flow upon dubbing.

When the A/V information is recorded to the hard disk apparatus by using the information recording and reproducing apparatus, if the A/V information recorded in the hard disk apparatus is dubbed to the optical disk recording medium, the dubbing flag 203 is turned on in the management information 210 of the A/V information. By the dubbing flag 203, whether or not the dubbing has been performed can be discriminated. If the dubbing flag 203 is ON, this means that the dubbing has been performed.

When the dubbing flag 203 is turned on, the time/date when the dubbing has been performed is recorded into the first-dubbing time/date information item 205 in the management information table.

If the A/V information to which the dubbing has been performed had already been dubbed, the number of dubbing times is increased by “1” and the increased number of dubbing times is stored. The information corresponding to the first dubbing is recorded in the dubbing time/date information.

In step 300, the management information is obtained. In step 301, a status of the dubbing flag 203 is discriminated.

If the dubbing flag is ON, step 304 follows. If the dubbing flag is OFF, step 302 follows. In step 302, the dubbing flag is turned on. In step 303, the dubbing time/date is set to the current time/date. In step 304, the number of dubbing times is increased by “1”. In step 305, the dubbing is started.

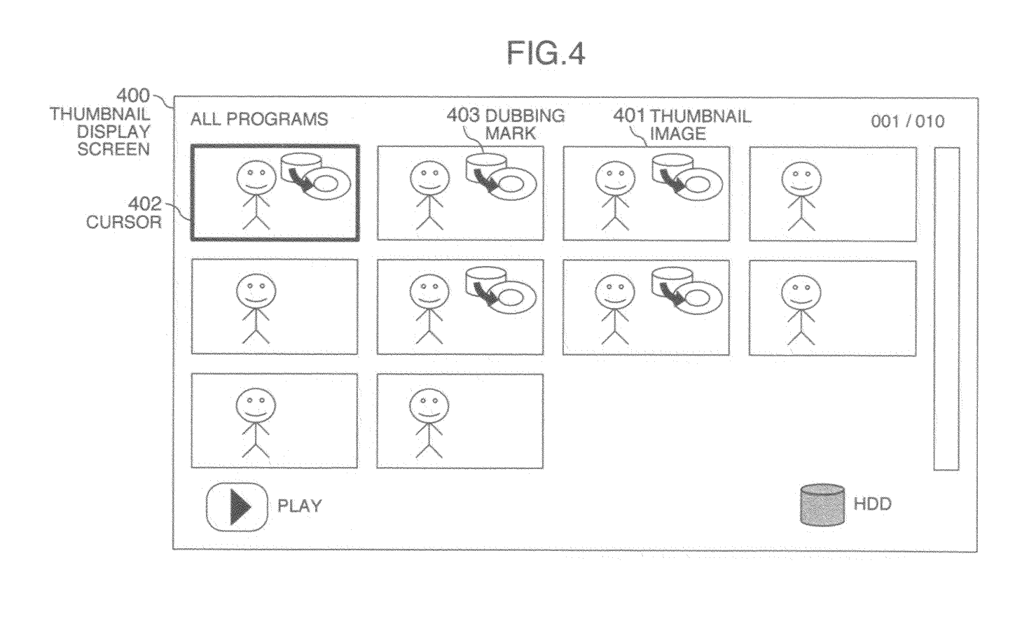

FIG. 4 is a thumbnail display screen for distinguishing the dubbed A/V information.

When the recorded A/V information is displayed as a thumbnail image onto a display screen of the monitor unit 115 such as a liquid crystal display screen or the like attached to the information recording and reproducing apparatus, a color or a shape of a display frame of the thumbnail image is changed so that the user can recognize the displayed A/V information as dubbed A/V information, or a mark for notifying that the dubbing has been performed is displayed in the thumbnail image. The number of dubbing times can be also displayed. A thumbnail display screen 400 is a display screen for displaying a list of thumbnail images of the recorded A/V information. A thumbnail image 401 of the A/V information is a thumbnail image of each A/V information. A cursor 402 indicates the A/V information selected at present. A dubbing mark 403 indicates that the dubbing has been performed.

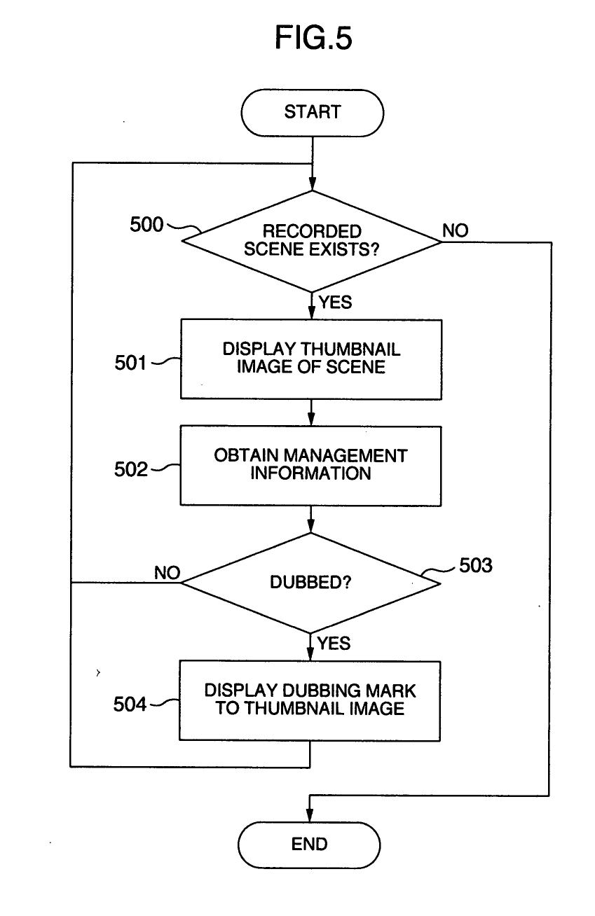

FIG. 5 shows a processing flow for the thumbnail display.

The thumbnail to be displayed can be set to only the dubbed A/V information by operating the operation menu which is displayed on the monitor unit 115 such as a liquid crystal display screen or the like attached to the information recording and reproducing apparatus or by operating buttons provided for a main body of the information recording and reproducing apparatus. On the contrary, only the A/V information which is not dubbed can be also displayed as a thumbnail. By this operation, when the display of the thumbnail is selected, the processing flow shown in FIG. 5 is executed. In step 500, whether or not the recorded A/V information exists is sequentially searched. If the recorded A/V information does not exist, the processing routine is finished. If the recorded A/V information exists, step 501 follows. In step 501, the thumbnail image of the A/V information is displayed and step 502 follows. In step 502, the dubbed information is obtained with reference to the management information of the A/V information displayed in step 501 and step 503 follows. In step 503, whether or not the obtained information has already been dubbed is discriminated. If the obtained information is not dubbed, the processing routine is returned to step 500 and advances to a process regarding the next A/V information. If the obtained information has already been dubbed, step 504 follows. In step 504, the mark showing that the dubbing has already been performed is displayed on the thumbnail image. The processing routine is returned to step 500 and advances to a process regarding the next A/V information.

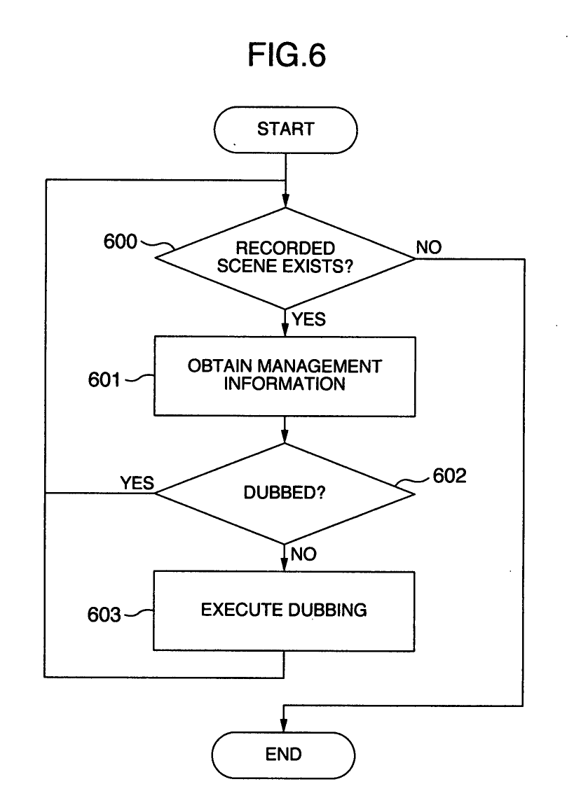

FIG. 6 shows a processing flow which is executed when the dubbed A/V information is not dubbed.

When all of the A/V information which is recorded to the hard disk apparatus is dubbed to the optical disk recording medium, the A/V information which has already been dubbed is not dubbed. In step 600, the presence or absence of the recorded A/V information is discriminated. If the recorded A/V information does not exist, the processing routine is finished. If the recorded A/V information exists, step 601 follows. In step 601, the management information of the recorded A/V information is obtained and the dubbing flag is obtained. In step 602, the obtained dubbing flag is referred to and whether or not the obtained information has already been dubbed is discriminated. If the obtained information has already been dubbed, it is determined that the dubbing process is unnecessary. To advance the processing routine to the next A/V information, the processing routine is returned to step 600. If the obtained information is not dubbed, step 603 follows. In step 603, the dubbing process is executed. After completion of the dubbing process, in order to advance the processing routine to the next A/V information, the processing routine is returned to step 600.

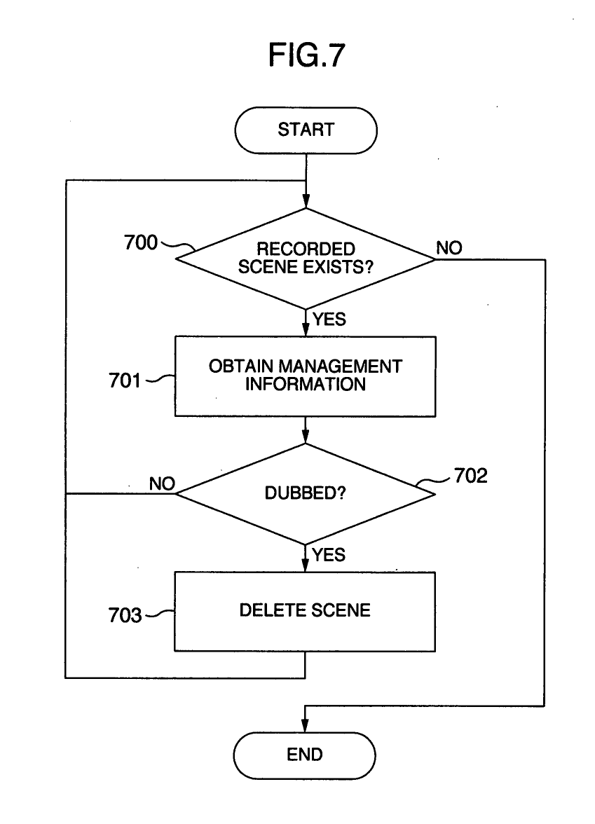

FIG. 7 shows a processing flow which is executed when the dubbed A/V information is deleted.

All of the dubbed A/V information in the A/V information which is recorded to the hard disk apparatus is deleted in a lump. In step 700, the presence or absence of the recorded A/V information is discriminated. If the recorded A/V information does not exist, the processing routine is finished. If the recorded A/V information exists, step 701 follows. In step 701, the management information of the recorded A/V information is obtained and the dubbing flag is obtained. In step 702, the obtained dubbing flag is referred to and whether or not the obtained information has already been dubbed is discriminated. If the obtained information is not dubbed, it is determined that the recorded A/V information is not deleted. To advance the processing routine to the next A/V information, the processing routine is returned to step 700. If the obtained information has already been dubbed, step 703 follows. In step 703, the A/V information is deleted. After completion of the deleting process of the A/V information, in order to advance the processing routine to the next A/V information, the processing routine is returned to step 700.

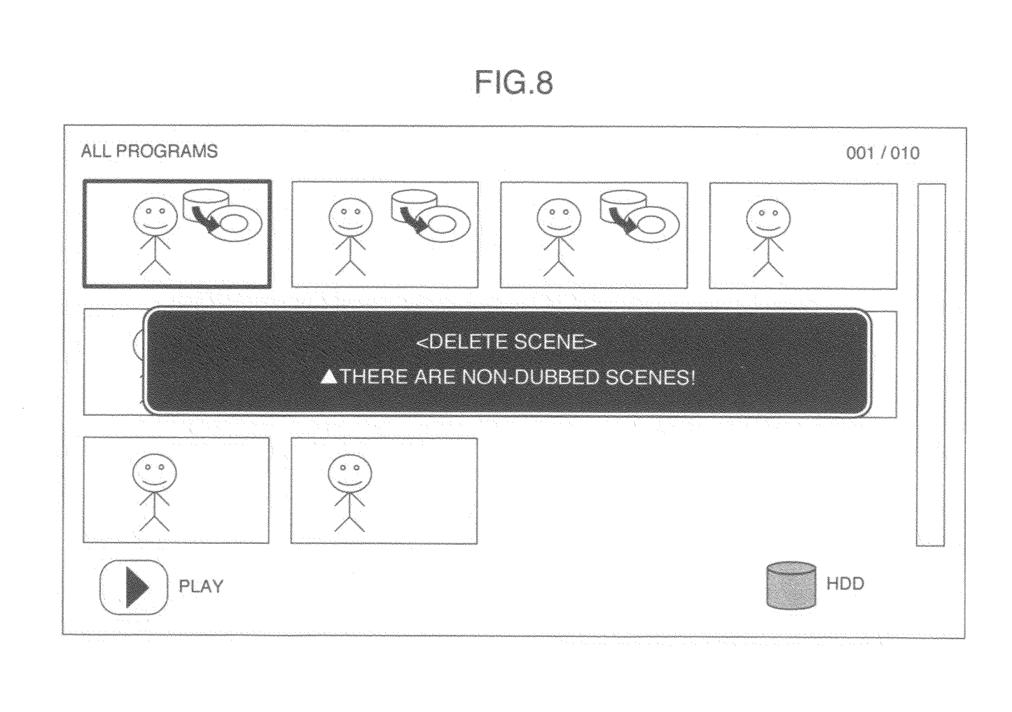

FIG. 8 is a display screen for displaying a warning when the dubbed A/V information is deleted.

When the process for deleting all of the A/V information which is recorded to the hard disk apparatus or the process in which the user selects and deletes a plurality of A/V information is executed, if the A/V information which is not dubbed is included in the A/V information serving as targets of the deletion, the user is notified of them. As notifying means, a message is displayed on a display screen of the monitor unit 115 of the information recording and reproducing apparatus like a dialog window.

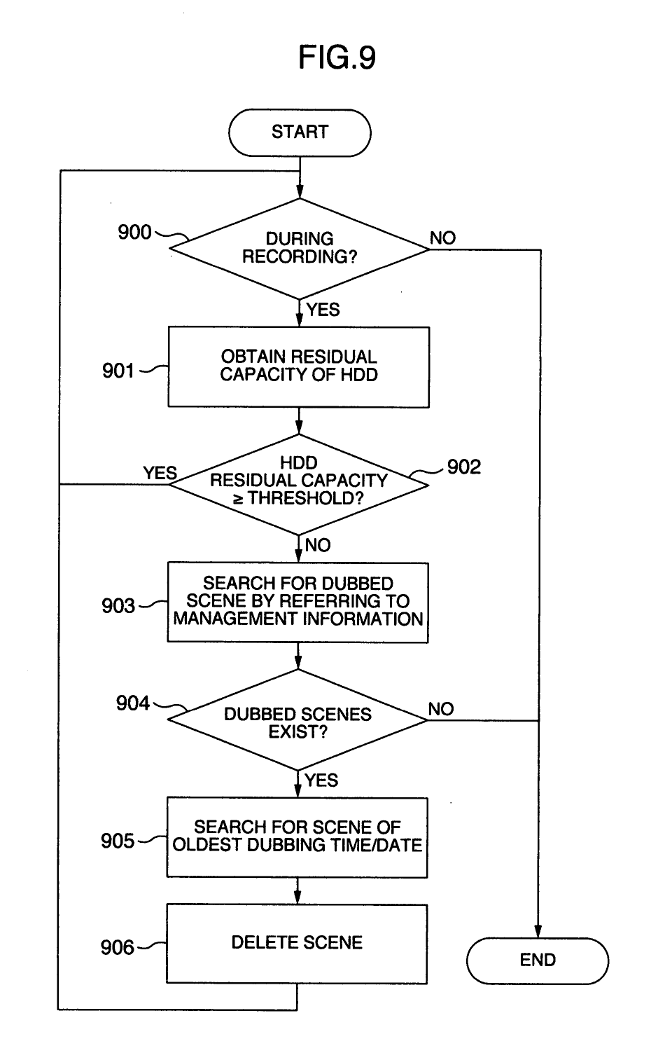

FIG. 9 shows a processing flow which is executed when the dubbed A/V information during the recording of the A/V information is automatically deleted.

If the residual amount of the hard disk apparatus decreases during the recording to the hard disk apparatus, the dubbed A/V information is automatically deleted, thereby assuring the capacity in which the information can be recorded. The deletion of the A/V information is executed simultaneously with the recording of the video information. With reference to the management information, the A/V information is deleted from the A/V information of the old dubbing date. The apparatus has a function of displaying a message onto the display screen during the recording in order to notify the user of the deletion of the A/V information when the A/V information is automatically deleted. The user is also notified of information showing which ones of the A/V information is deleted.

In step 900, whether or not the information recording and reproducing apparatus is executing the recording in the recording mode at present is discriminated. If it is not executing the recording, the processing routine is finished. If the information recording and reproducing apparatus is executing the recording, step 901 follows. In step 901, the residual capacity of the hard disk apparatus in which the information can be recorded is obtained and step 902 follows. In step 902, whether or not the recordable residual capacity of the hard disk apparatus is larger than a threshold value is discriminated. If the recordable residual capacity is larger than the threshold value, it is determined that the deletion of the dubbed A/V information is unnecessary. The processing routine is returned to step 900. If the recordable residual capacity is not larger than the threshold value, it is determined that it is necessary to delete the dubbed A/V information. The processing routine advances to step 903. In step 903, the dubbed A/V information is searched for with reference to the management information. In step 904, the presence or absence of the dubbed A/V information is discriminated. If the dubbed A/V information does not exist, the processing routine is finished. If the dubbed A/V information exists, step 905 follows. In step 905, the A/V information of the oldest dubbing time/date in the dubbed A/V information is searched for. In step 906, the searched A/V information is deleted and the processing routine is returned to step 900.

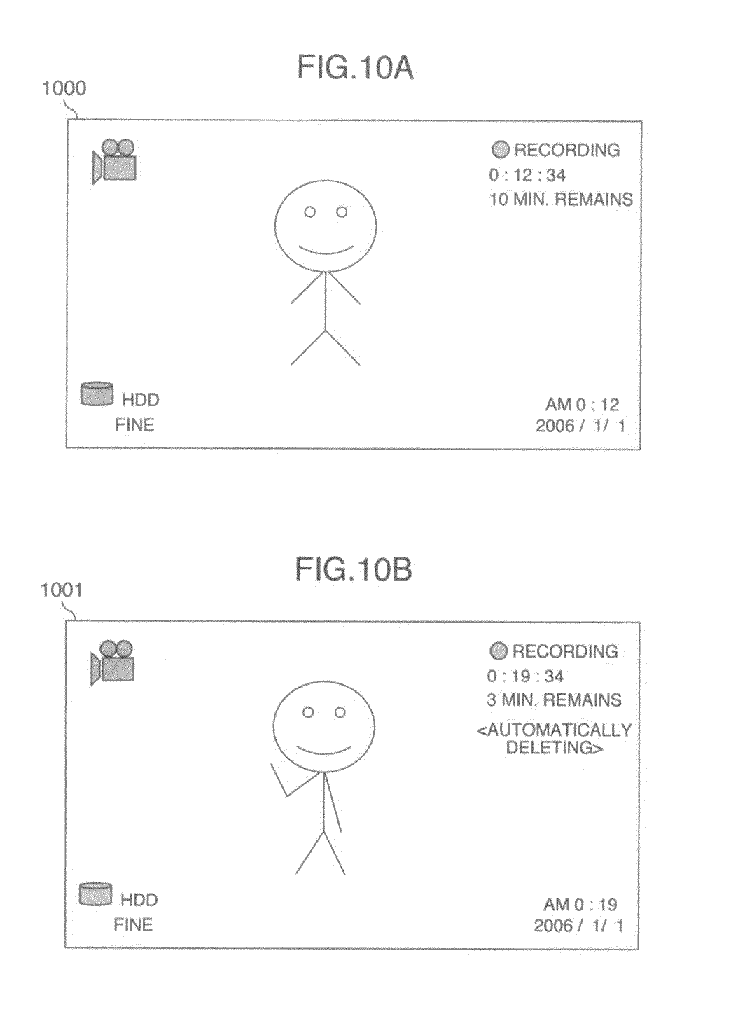

FIGS. 10A and 10B show display screens which are displayed when the dubbed A/V information is automatically deleted. In a display 1000 of the display screen during the recording shown in FIG. 10A, the information such as a residual capacity and the like of the hard disk apparatus is displayed. If the residual capacity of the hard disk apparatus decreases, the dubbed A/V information is deleted. At this time, in a display screen 1001 in FIG. 10B, a message to notify the user that the dubbed A/V information is being deleted is displayed.

It should be further understood by those skilled in the art that although the foregoing description has been made on embodiments of the invention, the invention is not limited thereto and various changes and modifications may be made without departing from the spirit of the invention and the scope of the appended claims.

1. An information recording and reproducing apparatus in which a plurality of recording media are mounted and which records audio/video information into said recording media, comprising:
an image pickup device;
recording means for recording video information from said image pickup device into a recording medium;
reproducing means for reproducing the video information recorded in said recording medium; and
dubbing means for dubbing the audio/video information from the recording medium to another recording medium,
wherein information showing that the audio/video information has been dubbed by said dubbing means is stored into the recording medium of a dubbing source side.

2. An apparatus according to claim 1, wherein
when the audio/video information recorded in the recording medium is displayed as a list onto a display screen,
if the audio/video information is the audio/video information which has already been dubbed by said dubbing means,
the audio/video information is displayed as a list so that it is indicated that the audio/video information has already been dubbed.

3. An apparatus according to claim 1, wherein
when all of the audio/video information recorded in the recording medium of the dubbing source side is dubbed into another recording medium by said dubbing means,
the audio/video information which has already been dubbed by said dubbing means among the audio/video information recorded in the recording medium of the dubbing source side is not dubbed.

4. An apparatus according to claim 1, wherein
when all of the audio/video information which has already been dubbed by said dubbing means among the audio/video information recorded in the recording medium of the dubbing source side is deleted,
the audio/video information serving as targets of the deletion is deleted without selecting the audio/video information by a user.

5. An apparatus according to claim 1, wherein
when the audio/video information recorded in the recording medium is deleted,
if the audio/video information which is not dubbed yet exists among the audio/video information serving as targets of the deletion, a user is requested to confirm whether or not the audio/video information is deleted.

6. An apparatus according to claim 1, wherein
when the audio/video information is being recorded in the recording medium,
if a residual amount of a recording capacity of said recording medium decreases,
the audio/video information which has already been dubbed by said dubbing means is deleted.

7. An apparatus according to claim 6, wherein
when the audio/video information is deleted,
the audio/video information is deleted from the audio/video information of the oldest dubbing time/date among the audio/video information which has already been dubbed by said dubbing means.

8. An apparatus according to claim 6, wherein
when the audio/video information which has already been dubbed by said dubbing means is deleted,
a message to notify a user that the audio/video information is being deleted is displayed on a display screen of said information recording and reproducing apparatus.
